(19) United States
(12) Patent Application Publication
(10) Pub. No.: US 2023/0252374 A1
(43) Pub. Date: Aug. 10, 2023

(54) METHODS AND INTERNET OF THINGS (IOT) SYSTEMS FOR MANAGING RETURN VISIT BASED ON CALL CENTER OF SMART GAS

(71) Applicant: CHENGDU QINCHUAN IOT TECHNOLOGY CO., LTD., Chengdu (CN)

(72) Inventors: Zehua SHAO, Chengdu (CN); Bin LIU, Chengdu (CN); Lei ZHANG, Chengdu (CN); Yong LI, Chengdu (CN); Yongzeng LIANG, Chengdu (CN)

(73) Assignee: CHENGDU QINCHUAN IOT TECHNOLOGY CO., LTD., Chengdu (CN)

(21) Appl. No.: 18/303,594

(22) Filed: Apr. 20, 2023

(30) Foreign Application Priority Data
Apr. 11, 2023 (CN) 202310378650.9

(51) Int. Cl. G06Q 10/0631; G16Y 10/35

(52) U.S. Cl. CPC G06Q 10/06311; G16Y 10/35

(57) ABSTRACT

The embodiments of the present disclosure provide methods for managing a return visit based on a call center of smart gas. The method may comprise: obtaining gas call consultation data of one or more gas users, the gas call consultation data including at least a call type distribution; determining a return visit gas user based on the gas call consultation data of one or more gas users; and determining return visit parameters based on the gas call consultation data of the return visit gas user and gas user features of the return visit gas user, the gas user features including at least a gas terminal type, and the return visit parameters including at least a return visit question set.

### CROSS-REFERENCE TO RELATED APPLICATIONS

This application claims priority to Chinese Patent Application No. 202310378650.9, filed on Apr. 11, 2023, and the entire contents of which are hereby incorporated by reference.

### TECHNICAL FIELD

The present disclosure relates to the field of gas user return visits, and in particular to methods and Internet of Things (IoT) systems for managing a return visit based on a call center of smart gas.

### BACKGROUND

For the conventional gas user return visit work, the return visit process may be mostly superficial and involve few substantive issues for gas users, thus it may be difficult to achieve a good effect of return visit, which may have a negative impact on users' experience of return visit and subsequent experience of gas use.

Therefore, it is desirable to provide a method for managing a return visit based on a call center of smart gas to determine the mean and content of return visit, thereby achieving targeted return visits to gas users, and improving the efficiency and service quality of return visit.

### SUMMARY

One or more embodiments of the present disclosure provide a method for managing a return visit based on a call center of smart gas. The method for managing the return visit based on the call center of smart gas may comprise: obtaining gas call consultation data of one or more gas users, the gas call consultation data including at least a call type distribution; determining a return visit gas user based on the gas call consultation data of one or more gas users; and determining return visit parameters based on the gas call consultation data of the return visit gas user and gas user features of the return visit gas user, the gas user features including at least a gas terminal type, and the return visit parameters including at least a return visit question set.

One or more embodiments of the present disclosure provide an Internet of Things (IoT) system for managing a return visit based on a call center of smart gas. The IoT system for managing the return visit based on the call center of smart gas may comprise a smart gas user platform, a smart gas service platform, a smart gas management platform, a smart gas sensor network platform and a smart gas object platform which interact sequentially. The smart gas management platform may include a smart customer service management sub-platform, a smart operation management sub-platform and a smart gas data center. The smart gas management platform may be configured to perform the following operations. The smart gas data center may obtain gas usage data from at least one gas terminal equipment through the smart gas sensor network platform and send the gas usage data to the smart gas management platform. The at least one gas terminal equipment may be configured in the smart gas object platform. The smart gas management platform may be configured to: obtain gas call consultation data of one or more gas users, the gas call consultation data including at least a call type distribution; determine a return visit gas user based on the gas call consultation data of one or more gas users; and determine return visit parameters based on the gas call consultation data of the return visit gas user and gas user features of the return visit gas user, the gas user features including at least a gas terminal type, and the return visit parameters including at least a return visit question set.

One or more embodiments of the present disclosure provide a non-transitory computer-readable storage medium. The storage medium may store computer instructions. When reading the computer instructions in the storage medium, a computer may execute the method for managing the return visit based on the call center of smart gas.

### BRIEF DESCRIPTION OF THE DRAWINGS

The present disclosure is further illustrated in terms of exemplary embodiments. These exemplary embodiments are described in detail with reference to the drawings. These embodiments are non-limiting exemplary embodiments, in which like reference numerals represent similar structures, wherein:

FIG. 1 is a structural diagram illustrating an Internet of Things (IoT) system for managing a return visit based on a call center of smart gas according to some embodiments of the present disclosure;

FIG. 2 is a flowchart illustrating an exemplary method for managing a return visit based on a call center of smart gas according to some embodiments of the present disclosure;

FIG. 3 is a flowchart illustrating an exemplary method for determining a return visit gas user according to some embodiments of the present disclosure;

FIG. 4 is a flowchart illustrating an exemplary method for determining return visit parameters according to some embodiments of the present disclosure;

FIG. 5 is a flowchart illustrating another exemplary method for determining return visit parameters according to some embodiments of the present disclosure;

FIG. 6 is a model structure diagram illustrating an occurrence probability prediction model according to some embodiments of the present disclosure; and

FIG. 7 is a model structure diagram illustrating a return visit effect prediction model according to some embodiments of the present disclosure.

### DETAILED DESCRIPTION

In order to more clearly illustrate the technical solutions related to the embodiments of the present disclosure, a brief introduction of the drawings referred to the description of the embodiments is provided below. Obviously, the drawings described below are only some examples or embodiments of the present disclosure. Those having ordinary skills in the art, without further creative efforts, may apply the present disclosure to other similar scenarios according to these drawings. Unless obviously obtained from the context or the context illustrates otherwise, the same numeral in the drawings refers to the same structure or operation.

It should be understood that the “system,” “device,” “unit,” and/or “module” used herein are one method to distinguish different components, elements, parts, sections, or assemblies of different levels. However, if other words can achieve the same purpose, the words can be replaced by other expressions.

As used in the disclosure and the appended claims, the singular forms “a,” “an,” and “the” include plural referents unless the content clearly dictates otherwise; the plural forms may be intended to include singular forms as well. In general, the terms “comprise,” “comprises,” and/or “comprising,” “include,” “includes,” and/or “including,” merely prompt to include steps and elements that have been clearly identified, and these steps and elements do not constitute an exclusive listing. The methods or devices may also include other steps or elements.

The flowcharts used in the present disclosure illustrate operations that the system implements according to the embodiments of the present disclosure. It should be understood that the foregoing or following operations may not necessarily be performed exactly in order. Instead, the operations may be processed in reverse order or simultaneously. Besides, one or more other operations may be added to these processes, or one or more operations may be removed from these processes.

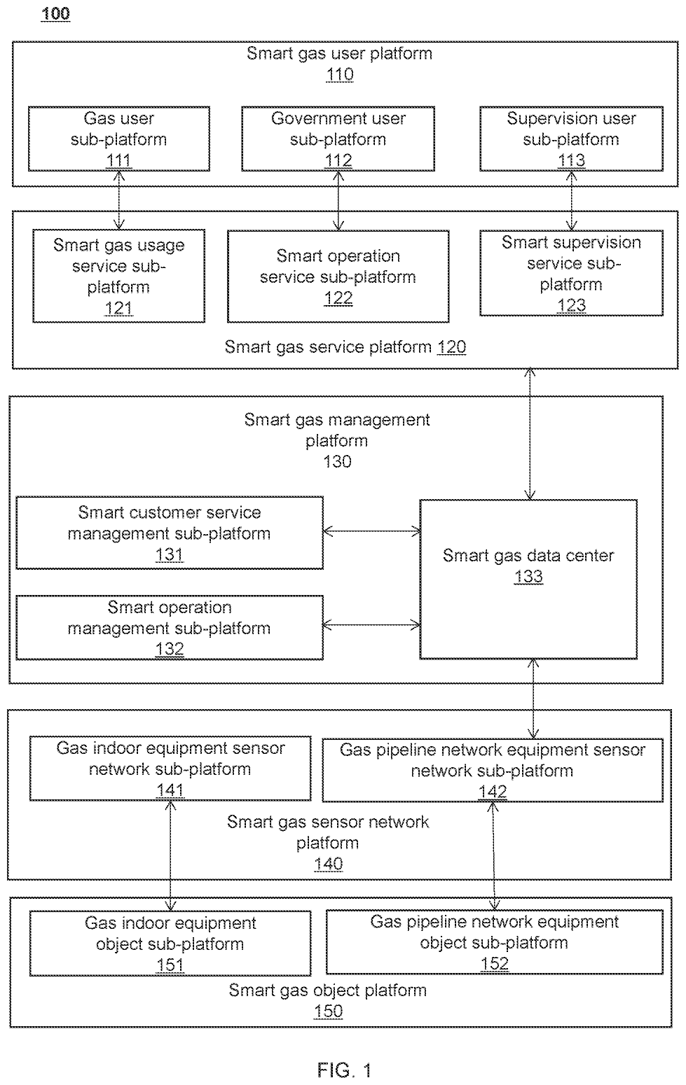

FIG. 1 is a structural diagram illustrating an Internet of Things (IoT) system for managing a return visit based on a call center of smart gas according to some embodiments of the present disclosure. In some embodiments, the IoT system 100 for managing the return visit based on the call center of smart gas may comprise a smart gas user platform 110, a smart gas service platform 120, a smart gas management platform 130, a smart gas sensor network platform 140 and a smart gas object platform 150.

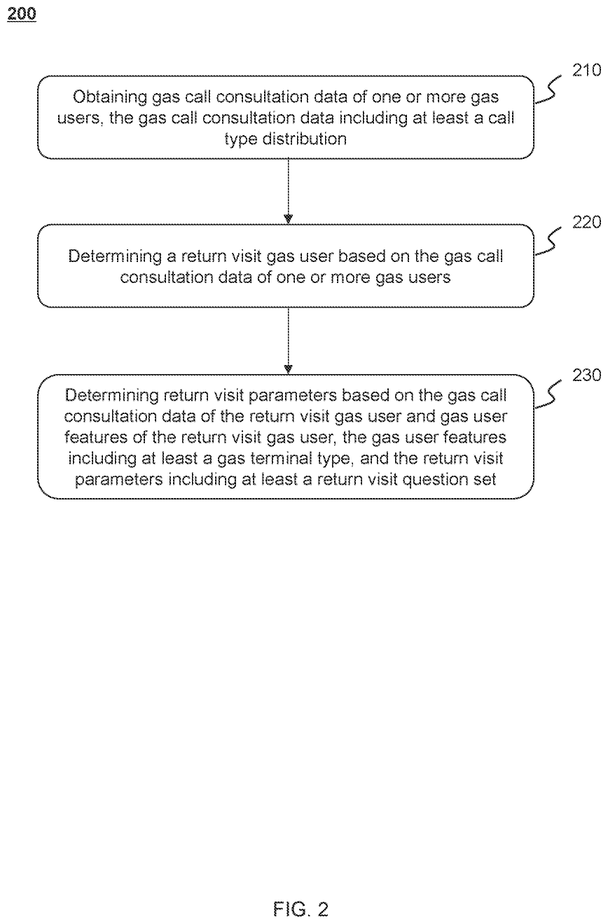

The smart gas user platform 110 may be a platform configured to interact with a user. In some embodiments, the smart gas user platform 110 may be configured as terminal equipment. For example, the terminal equipment may refer to a smart gas user terminal, and may include terminal equipment such as mobile terminal equipment, a tablet computer, or any combination thereof. In some embodiments, the smart gas user platform 110 may be configured to feed back customer service feedback information and/or return visit parameters to a gas user. For the descriptions of the return visit parameters, please refer to the descriptions in FIG. 2.

In some embodiments, the smart gas user platform 110 may include a gas user sub-platform 111, a government user sub-platform 112 and a supervision user sub-platform 113. In some embodiments, the smart gas user platform 110 may perform bidirectional interaction with the smart gas service platform 120 downwards, send gas user call information and/or a return visit parameter query instruction to the smart gas service platform 120, and receive the customer service feedback information and/or return visit parameters uploaded by the smart gas service platform 120.

The gas user sub-platform 111 may provide services related to safety gas usage for the gas user. The gas user may refer to a user who uses gas. In some embodiments, the gas user sub-platform 111 may perform information interaction with a smart gas usage service sub-platform 121 of the smart gas service platform 120 to obtain service reminders related to safety gas usage and solutions to gas problems.

The government user sub-platform 112 may provide gas operation data for a government user. The government user may refer to a user responsible for gas operation. In some embodiments, the government user sub-platform 112 may perform information interaction with a smart operation service sub-platform 122 of the smart gas service platform 120 to obtain the gas operation data.

The supervision user sub-platform 113 may supervise the operation of the entire IoT system 100 for managing the return visit based on the call center of smart gas for a supervision user. The supervision user may refer to a user of a safety supervision department. In some embodiments, the supervision user sub-platform 113 may perform information interaction with a smart supervision service sub-platform 123 of the smart gas service platform 120 to obtain services required by safety supervision.

The smart gas service platform 120 may be a platform configured to receive and transmit data and/or information. For example, the smart gas service platform 120 may upload the return visit parameters to the smart gas user platform 110. In some embodiments, the smart gas service platform may include the smart gas usage service sub-platform 121, the smart operation service sub-platform 122 and the smart supervision service sub-platform 123. The smart gas usage service sub-platform 121 may correspond to the gas user sub-platform 111, and may perform information interaction with the gas user sub-platform 111 to provide services of safety gas usage for the gas user. The smart operation service sub-platform 122 may correspond to the government user sub-platform 112, and may perform information interaction with the government user sub-platform 112 to provide the gas operation services for the government user. The smart supervision service sub-platform 123 may correspond to the supervision user sub-platform 113, and may perform information interaction with the supervision user sub-platform 113 to provide safety supervision services for the gas supervision user.

In some embodiments, the smart gas service platform 120 may perform bidirectional interaction with the smart gas data center 133 of the smart gas management platform 130 downwards, send a return visit parameter query instruction to the smart gas data center 133, and receive the return visit parameters uploaded by the smart gas data center 133.

The smart gas management platform 130 may refer to a platform that overall-plans and coordinates the connection and collaboration between various functional platforms, gathers all the information of the IoT, and provides perception management and control management functions for the operation system of the IoT. For example, the smart gas management platform 130 may determine a return visit gas user based on gas call consultation data of a gas user. The descriptions of the gas call consultation data and the return visit gas user may be found in the descriptions in FIG. 2.

In some embodiments, the smart gas management platform 130 may include a smart customer service management sub-platform 131, a smart operation management sub-platform 132 and a smart gas data center 133. In some embodiments, the smart customer service management sub-platform 131 and the smart operation management sub-platform 132 may respectively perform bidirectional interaction with the smart gas data center 133. For example, the smart customer service management sub-platform 131 and the smart operation management sub-platform 132 may obtain management data from the smart gas data center 133 and feed back the management data to the smart gas data center 133. In some embodiments, the smart gas data center 133 may summarize and store all operating data of the IoT system 100 for managing the return visit based on the call center of smart gas. In some embodiments, the smart customer service management sub-platform 131 may perform information interaction with the smart gas service platform 120 and the smart gas sensor network platform 140 respectively through the smart gas data center 133. For example, the smart gas data center 133 may receive parameter data related to gas terminal equipment uploaded by the smart gas sensor network platform 140, and send the parameter data related to the gas terminal equipment to the smart customer service management sub-platform 131 and the smart operation management sub-platform 132 for processing, and send the processed data to the smart gas service platform 120 and/or the smart gas sensor network platform 140. The parameter data related to the gas terminal equipment may include measurement data of a gas meter and environment (e.g., ambient temperature, atmospheric pressure, etc.) monitoring data.

In some embodiments, the smart gas management platform 130 may further include a processor. The processor may be configured to implement the method for managing the return visit based on the call center of gas.

The smart gas sensor network platform 140 may be a functional platform configured to manage sensor communication. The smart gas sensor network platform 140 may be configured as a communication network and a gateway to implement functions such as network management, protocol management, instruction management, and data analysis. In some embodiments, the smart gas sensor network platform 140 may be connected to the smart gas management platform 130 and the smart gas object platform 150 to implement the functions of perceptional information sensor communication and control information sensor communication. For example, the smart gas sensor network platform 140 may receive the parameter data related to the gas terminal equipment uploaded by the smart gas object platform 150, and send an instruction for obtaining the parameter data related to the gas terminal equipment to the smart gas object platform 150.

In some embodiments, the smart gas sensor network platform 140 may include a gas indoor equipment sensor network sub-platform 141 and a gas pipeline network equipment sensor network sub-platform 142, which may perform bidirectional interaction with a gas indoor equipment object sub-platform 151 and a gas pipeline network equipment object sub-platform 152 of the smart gas object platform 150.

The smart gas object platform 150 may be a functional platform for perceptional information generation and control information execution. In some embodiments, the smart gas object platform 150 may include the gas indoor equipment object sub-platform 151 and the gas pipeline network equipment object sub-platform 152. The gas pipeline network equipment object sub-platform 152 may be provided with a gas gate station compressor, pressure regulation equipment, a gas flow meter, valve control equipment, a thermometer, a barometer, etc. The gas flow meter may be used to obtain actual transportation flow of a gas pipeline; the thermometer may be used to obtain gas temperature in the gas pipeline; and the barometer may be used to obtain gas pressure in the gas pipeline. The gas indoor equipment object sub-platform 151 may be provided with indoor equipment (e.g., a gas meter). Data related the indoor equipment may be uploaded to the smart gas data center 133 through the gas indoor equipment sensor network sub-platform 141.

In some embodiments of the present disclosure, the return visit management based on the call center of smart gas may be implemented through the IoT functional architecture of five platforms, thereby completing a closed loop of information flow, and making the IoT information processing smoother and more efficient.

It should be noted that the above description of the IoT system for managing the return visit based on the call center of smart gas and modules thereof is only for the convenience of description, and does not limit the description to the scope of the embodiments. It can be understood that for those skilled in the art, after understanding the principle of the system, various modules may be combined arbitrarily, or a subsystem may be formed to connect with other modules without departing from the principle. For example, the smart gas management platform 130 and the smart gas sensor network platform 140 may be integrated into one component. As another example, each component may share one storage module, and each component may also have its own storage module. Such variations are all within the protection scope of the present disclosure.

FIG. 2 is a flowchart illustrating an exemplary method for managing a return visit based on a call center of smart gas according to some embodiments of the present disclosure. As shown in FIG. 2, the process 200 may include the following operations. In some embodiments, the process 200 may be executed by a processor in a smart gas management platform 130.

In 210, gas call consultation data of one or more gas users may be obtained, the gas call consultation data including at least a call type distribution.

The gas call consultation data may refer to statistical data related to a type of a call made between a gas user and a gas call center within a preset time period. The gas call consultation data may include a count of a gas user, a total number of calls and a call type distribution. A duration of the preset time period may be preset, for example, within one year before the current time point.

The call type distribution may refer to a ratio of a number of various types of calls made between the gas user and the call center to the total number of calls. The types of calls may include a complaint, maintenance, an inquiry, purchase, or the like. For example, the call type distribution may be “33% of complaint calls, 38% of maintenance calls, 19% of consultation calls, and 10% of purchase calls”.

For example, the content of the gas call consultation data may be that “the number of the gas user is 0147, the total number of calls is 10, of which the complaint calls account for 30%, the maintenance calls account for 30%, the consultation calls account for 20%, and the purchase calls account for 20%”. In some embodiments, the gas call consultation data may be data in a vector form. For example, as for the gas call consultation data of the No. 0147 gas user in the above example, the corresponding vector may be (0147, 10, 30%, 30%, 20%, 20%).

The gas call consultation data may be obtained based on call record data of the call center.

In 220, a return visit gas user may be determined based on the gas call consultation data of one or more gas users.

The return visit gas user may refer to a gas user who needs to make a return visit later.

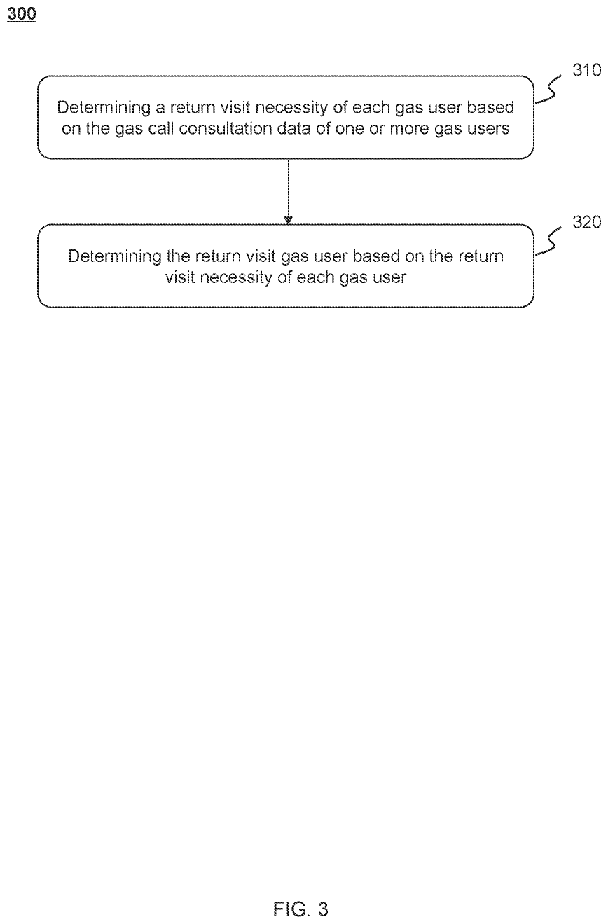

In some embodiments, a return visit necessity of each gas user may be determined based on the gas call consultation data of one or more gas users, and the return visit gas user may be determined based on the return visit necessity of each gas user. More descriptions of the return visit necessity and the method for determining the return visit gas users may be found in the descriptions in FIG. 3.

In 230, return visit parameters may be determined based on the gas call consultation data of the return visit gas user and gas user features of the return visit gas user, the gas user features including at least a gas terminal type, and the return visit parameters including at least a return visit question set.

The gas user features may refer to data that can reflect gas usage features of the gas user. The gas user features may include a gas terminal type of the gas user, a volume of the gas user and a type of the gas user.

The gas terminal type may refer to a type of gas terminal equipment used by the gas user. The gas terminal type may include a welding gun, a gas stove, a gas boiler, or the like.

The volume of the gas user may refer to data that can reflect a count of gas facilities used by the gas user. The volume of the gas user may include a count of the gas terminal equipment used by the gas user. For example, the volume of the gas user may be that “the count of the gas terminal equipment used by the gas user is 5”.

The type of the gas user may include a residential user, a commercial user, and a company user.

Exemplarily, the content of the gas user features may be that “the type of the gas terminal equipment is the gas stove, the count is 3, and the type of the gas user is the commercial user”. In some embodiments, the gas user features may be data in the vector form. For example, as for the gas user features in the above example, the corresponding vector may be (1, 3, 2), wherein, for the element of the first dimension, 1 may be preset to represent the welding gun, 2 may be preset to represent the gas stove, 3 may be preset to represent the gas boiler, etc.; for the element of the second dimension, its value may directly represent the count of the gas terminal equipment; and for the element of the third dimension, 1 may be preset to represent the residential user, 2 may be preset to represent the commercial user, 3 may be preset to represent the company user, etc.

The gas user features may be determined by obtaining an installation record of the gas terminal equipment used by the gas user based on the smart gas object platform 150.

The return visit parameters may refer to data related to a return visit content and/or a return visit form when a customer service agent conducts the return visit to the return visit gas user. The return visit parameters may include the return visit question set, and the return visit form may include a network return visit, a telephone return visit, a door-to-door return visit, or the like.

The return visit question set may refer to a collection of questions asked by the customer service agent to the return visit gas user when conducting the return visit to the return visit gas user. For example, the return visit question set may be that “Is the gas supply sufficient? Does the equipment fail again? . . . ”

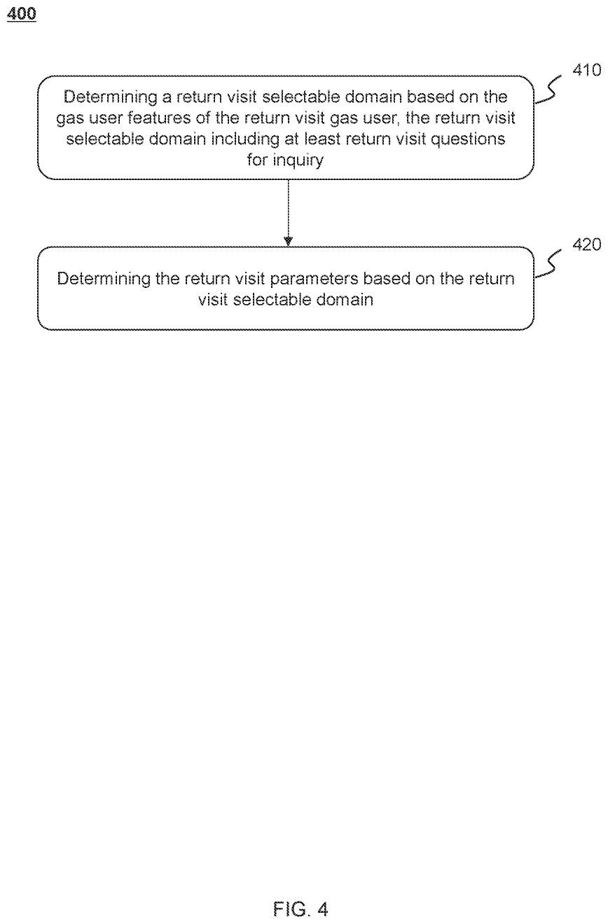

In some embodiments, a return visit selectable domain may be determined based on the gas user features of the return visit gas user, and the return visit parameters may be determined based on the return visit selectable domain. More descriptions of the return visit selectable domain and the method for determining the return visit parameters may be found in the descriptions in FIG. 4.

In some embodiments of the present disclosure, the method for managing the return visit based on the call center of gas may enhance the pertinence of the determined return visit questions for gas users, thereby improving the efficiency and service quality of the return visit.

It should be noted that the above description about the process 200 is for illustration and description purposes only, and does not limit the scope of application of the present disclosure. For those skilled in the art, various modifications and alterations may be made to the process 200 under the guidance of the present disclosure. However, such modifications and alterations are still within the scope of the present disclosure. For example, the return visit gas user may be determined using other methods.

FIG. 3 is a flowchart illustrating an exemplary method for determining a return visit gas user according to some embodiments of the present disclosure. As shown in FIG. 3, the process 300 may include the following operation. In some embodiments, the process 300 may be performed by a processor in a smart gas management platform 130.

In 310, a return visit necessity of each gas user may be determined based on the gas call consultation data of one or more gas users.

The return visit necessity may refer to a degree of necessity for the return visit to the gas user. In some embodiments, the return visit necessity may be represented by a value within a range of [0, 100]. The larger the value is, the higher the degree of necessity for the return visit to the corresponding gas user may be.

In some embodiments, the return visit necessity of each gas user may be determined based on the gas call consultation data of one or more gas users according to a preset rule. For example, the preset rule may be that the return visit necessity of the gas user may be positively correlated with a total number of calls in the gas call consultation data, positively correlated with a ratio of complaint calls and maintenance calls, and negatively correlated with a ratio of purchase calls, etc.

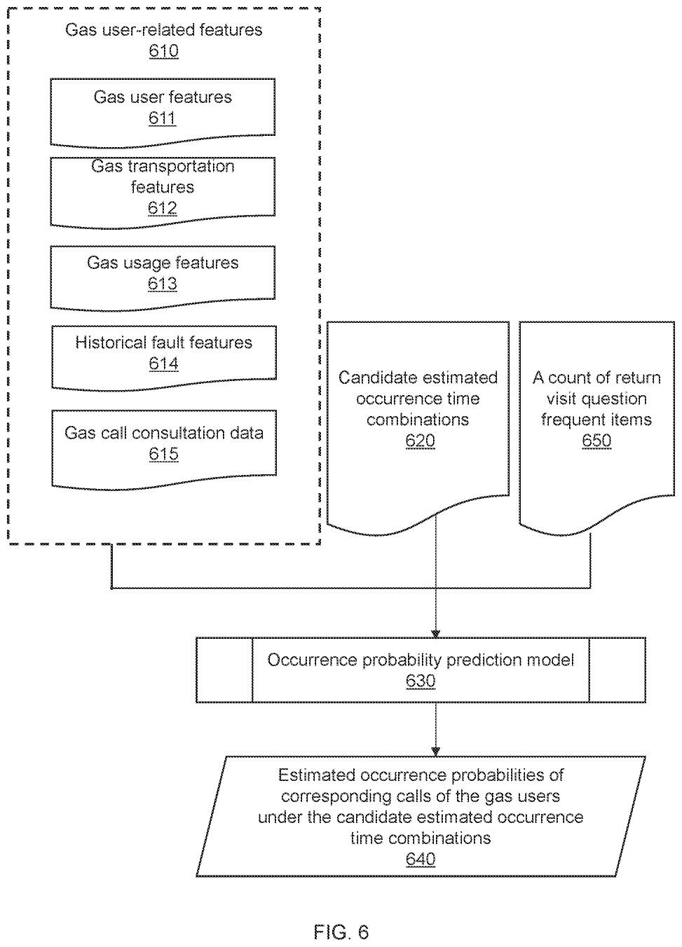

In some embodiments, for each gas user, an estimated occurrence probability of a corresponding call of the gas user under each candidate estimated occurrence time combination may be determined based on the gas user-related features including the gas call consultation data through an occurrence probability prediction model. The candidate estimated occurrence time combination may include one or more estimated occurrence times of different types of calls in the future, and the occurrence probability prediction model may be a machine learning model. The return visit necessity may be determined based on the estimated occurrence probability. The descriptions of the occurrence probability prediction model and the gas user-related features may be found in the descriptions in FIG. 6.

The estimated occurrence time combination may refer to a set of estimated occurrence times of various types of calls in the future. For example, the estimated occurrence time combination may be that “the estimated occurrence time of the complaint call may be 3 days after the current time, the estimated occurrence time of the maintenance call may be 40 days after the current time, the estimated occurrence time of the consultation call may be 7 days after the current time, and the estimated occurrence time of the purchase call may be 100 days after the current time.” In some embodiments, the estimated occurrence time combination may be data in the vector form. For example, as for the estimated occurrence time combination in the above example, the corresponding vector may be (3, 40, 7, 100).

The candidate estimated occurrence time combinations may refer to candidate sample estimated occurrence time combinations for determining a first candidate estimated occurrence time combination and/or a target estimated occurrence time combination. The form of the candidate estimated occurrence time times may be the same as that of the estimated occurrence time combination. The estimated occurrence time of each type of call included in the candidate estimated occurrence time combinations in the future may be a random value, or may be manually preset based on experience. The descriptions of the first candidate estimated occurrence time combination and the target estimated occurrence time combination may be found in the following contents.

In some embodiments, the corresponding candidate estimated occurrence time combination with the highest estimated occurrence probability of the call in a plurality of candidate estimated occurrence time combinations may be determined as the first candidate estimated occurrence time combination, and the return visit necessity may be determined based on the first candidate estimated occurrence time combination. For example, the return visit necessity may be negatively correlated with the estimated occurrence time of the complaint calls and the maintenance calls in the first candidate estimated occurrence time combination, and positively correlated with the estimated occurrence time of the consultation calls and the purchase calls in the first candidate estimated occurrence time combination.

In some embodiments, the candidate estimated occurrence time combination that satisfies an occurrence probability threshold condition may be determined as the target estimated occurrence time combination; and the return visit necessity may be determined by performing weighting on the at least one target estimated occurrence time combination.

Satisfying the occurrence probability threshold condition may refer to that the estimated occurrence probability of the corresponding call of the candidate estimated occurrence time combination may be greater than an occurrence probability threshold. The occurrence probability threshold may be a system default value, an experience value, an artificial preset value, etc. or any combination thereof, and may be set according to actual needs, which is not limited in the present disclosure.

In some embodiments, a weight value corresponding to the at least one target estimated occurrence time combination may be positively correlated with the estimated occurrence probability of the corresponding call.

In some embodiments, the method for determining the return visit necessity by performing weighting on the at least one target estimated occurrence time combination may be shown in the following formula (1):

H=Σᵢ₌₁^{N}kᵢ·f(tᵢ₁,tᵢ₂,tᵢ₃,tᵢ₄) (1).

Where H represents the return visit necessity after performing weighting on the at least one target estimated occurrence time combination; N represents a count of the target estimated occurrence time combinations; i represents the ith target estimated occurrence time combination, and 1≤i≤N; kᵢ represents a weight value corresponding to the ith target estimated occurrence time combination; tᵢ₁, tᵢ₂, tᵢ₃ and tᵢ₄ respectively represent the estimated occurrence time of the complaint calls, the estimated occurrence time of the maintenance calls, the estimated occurrence time of the consultation calls, and the estimated occurrence time of the purchase calls in the ith target estimated occurrence time combination; and f (tᵢ₁,tᵢ₂,tᵢ₃,tᵢ₄) represents a functional relational expression for determining the return visit necessity based on the ith target estimated occurrence time combination. Exemplarily, the specific mapping relationship of f (tᵢ₁, tᵢ₂, tᵢ₃, tᵢ₄) may be shown in the following formula (2):

$$f ( {t}_{i 1} , {t}_{i 2} , {t}_{i 3} , {t}_{i 4} ) = {a}_{1} \cdot {t}_{i 1} + {a}_{2} \cdot {t}_{i 2} + \frac{{a}_{3}}{{t}_{i 3}} + \frac{{a}_{4}}{{t}_{i 4}} . \qquad ( 2 )$$

Where α₁, α₂, α₃, and α₄ are constants greater than 0, specific values of which may be preset; and the remaining variables have the same meanings as formula (1).

In 320: the return visit gas user may be determined based on the return visit necessity of each gas user.

In some embodiments, a gas user whose return visit necessity satisfies a return visit threshold condition may be determined as the return visit gas user. Different gas users may have different return visit thresholds. The return visit thresholds of the gas users may be related to historical return visit frequencies of gas users.

Satisfying the return visit threshold condition may mean that the return visit necessity is greater than the return visit threshold. The return visit threshold may be a system default value, an experience value, an artificial preset value, etc. or any combination thereof, and may be set according to actual needs, which is not limited in the present disclosure.

In some embodiments, different return visit thresholds may be set for different gas users.

In some embodiments, the return visit threshold corresponding to the gas user may be related to the historical return visit frequency of the gas user. For example, the return visit threshold corresponding to the gas user may be positively correlated with the historical return visit frequency of the gas user.

The historical return visit frequency of the gas user may refer to a frequency of historical return visits of the gas user. For example, the historical return visit frequency may be 1 time/month.

In some embodiments of the present disclosure, the return visit gas user may be determined through the above method, which may meet the return visit needs of most users who need the return visit, reduce unnecessary return visits, and improve the efficiency and quality of the return visit work. The estimated occurrence probability of the corresponding call under each candidate estimated occurrence time combination may be determined by the model, which may ensure the accuracy of the determination result and improve the efficiency of the determination work. The method for determining the return visit necessity may effectively improve the accuracy and adaptability of the determined return visit necessity. Different return visit thresholds may be set for different gas users, which may further improve the adaptability of the determined return visit necessity.

It should be noted that the above description about the process 300 is for illustration and description purposes only, and does not limit the scope of application of the present disclosure. For those skilled in the art, various modifications and alterations may be made to the process 300 under the guidance of the present disclosure. However, such modifications and alterations are still within the scope of the present disclosure. For example, the return visit threshold may be determined using other methods.

FIG. 4 is a flowchart illustrating an exemplary method for determining return visit parameters according to some embodiments of the present disclosure. As shown in FIG. 4, the process 400 may include the following operations. In some embodiments, the process 400 may be performed by a processor in a smart gas management platform 130.

In 410, a return visit selectable domain may be determined based on the gas user features of the return visit gas user, the return visit selectable domain including at least return visit questions for inquiry.

The return visit selectable domain may refer to a return visit question set consisting of historical return visit questions of return visit gas users with the same gas user features. For example, the gas user features of the return visit gas user may be that “the type of the gas terminal equipment is the gas stove, the number is 3, and the type of the gas user is the commercial user”, and the corresponding return visit selectable domain may be that “Whether new gas equipment needs to be purchased? Does the equipment fail again? . . . ”. As another example, the gas user features of the return visit gas user may be that “the type of the gas terminal equipment is the gas stove, the number is 1, and the type of the gas user is the residential user”, and the corresponding return visit selectable domain may be that “Is the gas supply sufficient? Does the equipment fail again? . . . ”. More descriptions of the gas user features and the return visit gas user may be found in the descriptions in FIG. 2.

The return visit selectable domain may be determined based on a historical return visit record.

In 420: the return visit parameters may be determined based on the return visit selectable domain.

In some embodiments, a return visit question set in the return visit parameters may be formed by randomly selecting several return visit questions from the return visit selectable domain. More descriptions of the return visit question set may be found in the descriptions in FIG. 2.

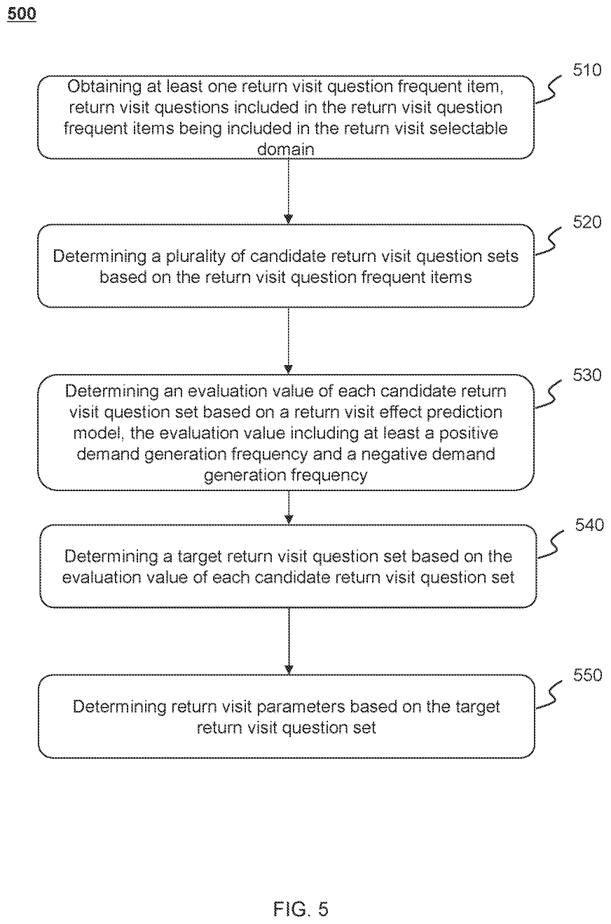

In some embodiments, the return visit parameters may be determined based on the method in FIG. 5.

FIG. 5 is a flowchart illustrating another exemplary method for determining return visit parameters according to some embodiments of the present disclosure. As shown in FIG. 5, the process 500 may include the following operations. In some embodiments, the process 500 may be performed by a processor in a smart gas management platform 130.

In 510, at least one return visit question frequent item may be obtained, return visit questions included in the frequent return visit question items being included in the return visit selectable domain.

The return visit question frequent item may refer to a return visit question combination whose number of questioning (referred to as a support degree hereinafter) is greater than or equal to a support degree threshold in a historical return visit process with a relatively good return visit effect. The return visit question combination may refer to a collection of return visit questions consisting of any number of return visit questions in the return visit selectable domain. The return visit effect of the historical return visit process may be determined based on a behavior of a historical return visit gas user after the historical return visit, and may include two return visit effects of “relatively good” and “relatively poor”. For example, if a demand of the historical return visit gas user for gas purchase increases after the historical return visit, it may be considered that the return visit effect is relatively good. As another example, if the count of complaints and maintenance needs of the historical return visit gas user increases after the historical return visit, it may be considered that the return visit effect is relatively poor. The support degree threshold may be a system default value, an experience value, an artificial preset value, etc. or any combination thereof, and may be set according to actual needs, which is not limited in the present disclosure.

An exemplary process for determining the return visit question frequent items may include the following operations. Taking the following historical return visit records of return visit gas users with the same gas user features as an example, the content of the historical return visit records may be that “return visit process 1: the return visit question set includes a question a, a question b, a question c, a question e, and a question g, and the return visit effect is relatively good; return visit process 2: the return visit question set includes a question a, a question b, a question c, a question d, and a question e, and the return visit effect is relatively poor; return visit process 3: the return visit question set includes a question c, a question e, a question f, a question g, and a question i, and the return visit effect is relatively good; and return visit process 4: the return visit question set includes a question c, a question d, a question e, a question g, and a question h, and the return visit effect is relatively good.” Assuming that the support degree threshold is set to 2, according to the historical return visit processes with relatively good return visit effects, for example, the support degree of a return visit question combination ceg (the return visit question combination composed of question c, question e and question g) may be statistically obtained as 3 (in all the historical return visit processes with relatively good return visit effects, the historical return visit processes of the return visit questions including the return visit question combination ceg may be three historical return visit processes, i.e., the return visit process 1, the return visit process 3 and the return visit process 4), which is greater than the support degree threshold, and then the return visit question combination ceg may be taken as a return visit question frequent item. As another example, the support degree of a return visit question combination cf (the return visit question combination composed of the question c and the question f) may be statistically obtained as 1 (in all the historical return visit processes with relatively good return visit effects, the historical return visit process of the return visit questions including the return visit question combination cf may only be the return visit process 3), which is less than the support degree threshold, and then the return visit question combination cf may not be taken as a return visit question frequent item. The descriptions of the return visit question set may be found in the descriptions in FIG. 2.

In some embodiments, the return visit question frequent item may be determined based on algorithms such as Apriori and FP Tree.

In some embodiments, in the process of determining the return visit question frequent item, the support degree of each question combination may be related to a gas feature consistency between the historical return visit gas user in the historical return visit record and the current return gas user. The gas feature consistency may be determined based on the gas user features, gas transportation and usage features, historical fault features and the gas call consultation data.

The gas feature consistency may refer to a comprehensive consistency between the gas user features, the gas transportation features, the gas usage features, the historical fault features and the as call consultation data of the historical return visit gas user in the historical return visit record and the gas user features, the gas transportation features, the gas usage features, the historical fault features and the gas call consultation data of the current return visit gas user. The gas feature consistency may be represented by a value within a range of [0,1]. More descriptions of the gas user features and the gas call consultation data may be found in the descriptions in FIG. 2.

The gas transportation features may refer to data reflecting features of gas transported in a gas pipeline. The gas transportation features may include a temperature, a pressure and a flow velocity of gas during pipeline transportation. For example, the gas transportation features may be that “the temperature of gas during pipeline transportation is 20° C., the pressure of gas during pipeline transportation is 3 MPa, and the flow velocity of gas during pipeline transportation is 8 m/s”. In some embodiments, the gas transportation features may be data in a vector form. For example, as for the gas transportation features in the above example, the corresponding vector may be (20, 3, 8).

The gas transportation features may be determined based on a thermometer, a barometer and a flow meter arranged on a smart gas object platform 150.

The gas usage features may refer to data reflecting features of a gas users when using the gas. The gas usage features may include a calorific value of gas, a gas usage frequency, an average duration of single gas usage, and a daily average gas consumption, etc. For example, the gas usage features may be that “the calorific value of gas is 36 MJ/m³, the gas usage frequency is 10 times/day, the average duration of single gas usage is 40 minutes, and the average daily gas consumption is 0.6 m³”. In some embodiments, the gas usage features may be data in a vector form. For example, as for the gas usage features in the above example, the corresponding vector may be (36, 10, 40, 0.6).

The gas usage features may be determined based on a gas meter arranged on the smart gas object platform 150.

The historical fault features may refer to data reflecting features of the historical fault conditions of the gas terminal equipment of the gas user. The historical fault features may include a count of various faults that have occurred in the gas terminal equipment of the gas user. For example, the historical fault features may be that “the gas pressure is insufficient for 2 times, and the gas pipeline is broken for 3 times”. In some embodiments, the historical fault features may be data in a vector form. For example, as for the historical fault features of the above example, the corresponding vector may be (2, 3).

The historical fault features may be determined based on a repair record of the gas user.

In some embodiments, a historical gas feature vector and a current gas feature vector may be constructed correspondingly based on the gas user features, the gas transportation features, the gas usage features, the historical fault features and the gas call consultation data of the historical return visit gas user and the current return visit gas user, and a gas feature consistency between the historical return visit gas user and the current return visit gas user may be determined based on a similarity between the historical gas feature vector and the current gas feature vector.

The historical gas feature vector may be constructed in various ways. For example, the historical gas feature vector may be obtained by combining vectors corresponding to the gas user features, the gas transportation features, the gas usage features, the historical fault features and the gas call consultation data of the historical return visit gas user. For example, the gas user feature vector of the historical return visit gas user may be (1, 3, 2), the gas transportation feature vector may be (20, 3, 8), the gas usage feature vector may be (36, 10, 40, 0.6), the historical fault feature vector may be (2, 3), and the gas call consultation data vector may be (0147, 10, 30%, 30%, 20%, 20%), and then the combined historical gas feature vector may be (1, 3, 2, 20, 3, 8, 36, 10, 40, 0.6, 2, 3, 0147, 10, 30%, 30%, 20%, 20%).

The method for constructing the current gas feature vector may be the same as the method for constructing the historical gas feature vector.

The similarity between the historical gas feature vector and the current gas feature vector may be determined based on a vector distance between the historical gas feature vector and the current gas feature vector. For example, the similarity between the historical gas feature vector and the current gas feature vector may be negatively correlated with the vector distance. The vector distance may be determined by distance calculation methods such as Euclidean distance, Manhattan distance, Chebyshev distance and Mahalanobis distance.

In some embodiments, the gas feature consistency between the historical return visit gas user and the current return visit gas user may be positively correlated with the similarity between the historical gas feature vector and the current gas feature vector.

Exemplarily, if the return visit question frequent item is related to the gas feature consistency, the determination process of the return visit question frequent item may include the following operations. Taking the following historical return visit records of return visit gas users with the same gas user features as an example, the content of the historical return visit records may be that “Return visit process 1: the return visit question set includes a question a, a question b, a question c, a question e, and a question g, the return visit effect is relatively good, and the gas feature consistency is 0.8; return visit process 2: the return visit question set includes a question a, a question b, a question c, a question d, and a question e, the return visit effect is relatively poor, and the gas feature consistency is 0.9; return visit process 3: the return visit question set includes a question c, a question e, a question f, a question g, and a question h, the return visit effect is relatively good, and the gas feature consistency is 0.8; and return visit process 4: the return visit question set includes a question c, a question d, a question e, a question g, and a question h, the return visit effect is relatively good, and the gas feature consistency is 0.7.” Assuming that the support degree threshold is set to 2, according to the historical return visit process with relatively good return visit effect, for example, the support degree of a return visit question combination ceg may be calculated as 0.8+0.8+0.7=2.3 (in all the historical return visit processes with relatively good return visit effects, the historical return visit processes of the return visit questions including the return visit question combination ceg may include the return visit process 1, the return visit process 3 and the return visit process 4), which is greater than the support degree threshold; the support degree of a return visit question combination gh may be 0.8+0.7=1.5 (in all the historical return visit processes with relatively good return visit effects, the historical return visit processes of the return visit questions including the return visit question combination gh may be the return visit process 3 and the return visit process 4), which is less than the support degree threshold; and the support degree of a return visit question combination ab may be 0.8 (in all the historical return visit processes with relatively good return visit effects, the historical return visit process of the return visit questions including the return visit question combination ab may be only the return visit process 1), which is less than the support degree threshold. Accordingly, the return visit question combination ceg may be used as a return visit question frequent item, and the return visit question combination gh and return visit question combination ab may not be taken as a return visit question frequent item.

In 520, a plurality of candidate return visit question sets may be determined based on the return visit question frequent items.

The candidate return visit question set may refer to a candidate set composed of return visit questions for determining the return visit question set.

In some embodiments, the candidate return visit question set may be determined through the following process (S1-S4).

S1: In the return visit selectable domain, n return visit questions (Q1-Qn) may be randomly selected, wherein n may be a count of preset questions. More descriptions of the return visit selectable domain may be found in the descriptions in FIG. 4.

S2: It may be determined whether the return visit question belongs to a return visit question frequent item based on each return visit question Qi (i=1, 2, . . . , n) selected by S1 in turn.

S3: In response to a determination that the return visit question belongs to the return visit question frequent item, all the return visit questions included in the at least one return question frequent item to which the return visit question Qi belongs may be added to the candidate return visit question set; and in response to a determination that the return visit question does not belong to the return visit question frequent item, only the return visit question Qi may be added to the candidate return visit question set. Then the candidate return visit question set including at least the return visit question Q1-Qn may be obtained.

An exemplary process of performing S2 and S3 may include the following operations. Assuming that the return visit questions randomly selected from the return visit selectable domain include a question c, a question i and a question o; the return visit question frequent items including the question c include a return visit question frequent item A (including a question c, a question e, and a question g) and a return visit question frequent item B (including a question c, a question h, a question m, and a question p); a return visit question frequent item including a question i is not found; and the return visit question frequent item including a question o found in the query is a frequent return visit question item C (including a question f, a question h, and a question o), then the return visit questions included in the obtained candidate return visit question set may include a question c, a question e, a question f, a question g, a question h, a question i, a question m, a question o, and a question p.

S4: a plurality of candidate return visit question sets may be obtained by repeating S1-S3 for a preset number of times.

In some embodiments, the preset number of questions may be related to the return visit necessity to the current gas user. For example, the preset number of questions may be positively correlated with the return visit necessity of the current return visit gas user. More descriptions of the return visit necessity may be found in the descriptions in FIG. 3.

In 530: an evaluation value of each candidate return visit question set may be determined based on a return visit effect prediction model, the evaluation value including at least a positive demand generation frequency and a negative demand generation frequency.

The evaluation value may refer to data reflecting an estimated generation frequency of a positive demand and a negative demand of the current return visit gas user within a first time period after the return visit. The positive demand may include a purchase demand and a consultation demand; the negative demand may include a complaint demand and a maintenance demand; and a duration of the first time period may be preset, for example, 1 year.

The positive demand generation frequency may refer to the estimated generation frequency of the positive demand of the current returning visit gas user within the first time period after the return visit. For example, the positive demand generation frequency may be 2, which means that the estimated generation frequency of the positive demand of the current return visit gas user may be 2 times within the first time period after the return visit.

The negative demand generation frequency may refer to the estimated generation frequency of the negative demand of the current return visit gas user within the first time period after the return visit. For example, the negative demand generation frequency may be 3, which means that the estimated generation frequency of the negative demand of the current return visit gas user may be 3 times within the first time period after the return visit.

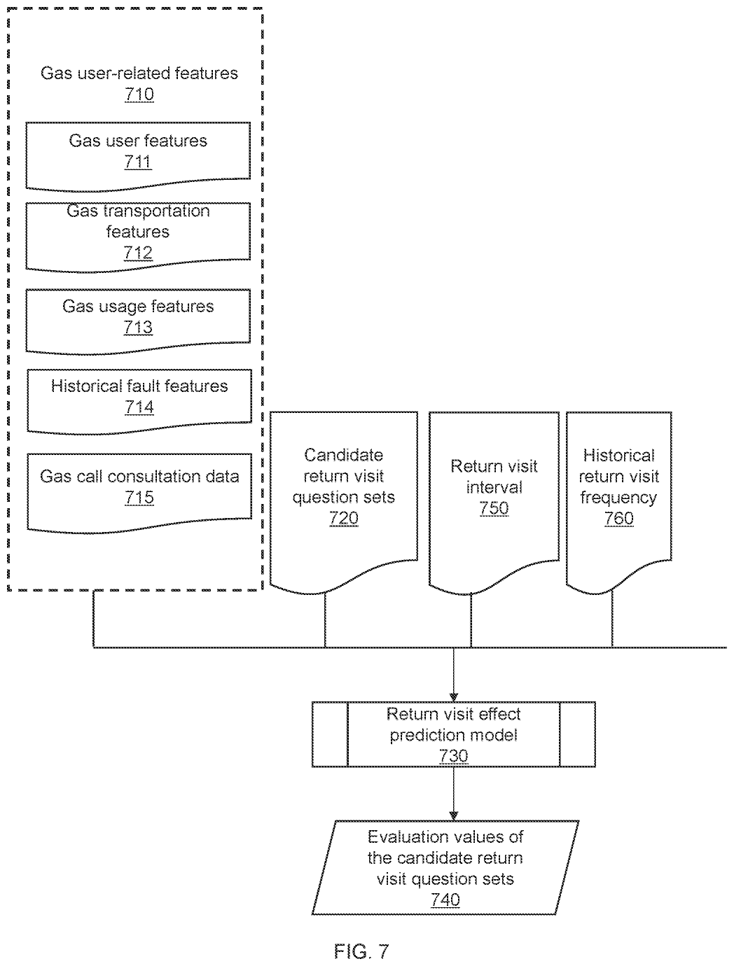

In some embodiments, the evaluation value of the candidate return visit question set may be determined based on the processing of a return visit effect prediction model on the candidate return visit question set. An occurrence probability prediction model may be a machine learning model. More descriptions of the return visit effect prediction model may be found in the descriptions in FIG. 7.

In 540, a target return visit question set may be determined based on the evaluation value of each candidate return visit question set.

The target return visit question set may refer to a set of return visit questions selected from each candidate return visit question set and used to determine the return visit question set.

The target return visit question set may be determined in various ways. For example, the candidate return visit question set satisfying a preset condition may be determined as the target return visit question set. The preset condition may be that in the evaluation value of the candidate return visit question set, positive demand generation frequency may be greater than a positive demand threshold and the negative demand generation frequency may be less than a negative demand threshold. Both the positive demand threshold and the negative demand threshold may be a system default value, an experience value, an artificial preset value, etc. or any combination thereof, and may be set according to actual needs, which is not limited in the present disclosure.

In 550, return visit parameters may be determined based on the target return visit question set.

In some embodiments, all the return visit questions included in all the target return visit question sets may be used as the return visit questions in the return visit question set included in the return visit parameters.

In some embodiments, the return visit parameters may further include a return visit interval. An input of the return visit effect prediction model may further include the return visit interval and a historical return visit frequency.

The return visit interval may refer to a time interval between a last return visit to a certain return visit gas user and an estimated next return visit to the return visit gas user. The return visit interval may be determined based on empirical manual estimation.

The historical return visit frequency may refer to a historical return visit frequency of the return visit gas user. For example, the historical return visit frequency may be 2 times/month. The historical return visit frequency may be determined based on the historical return visit records of the return visit gas user. More descriptions of the historical return visit frequency may be found in the descriptions of 320 in FIG. 3.

In some embodiments of the present disclosure, the adaptability of the determined return visit parameters may be effectively improved through the above method for determining the return visit parameters. The adaptability of the determined return visit parameters may be further improved by determining the return visit parameters through introducing the frequent return visit question items. When the return visit question frequent items are determined by counting the number of occurrences (support degree) through the historical return visit records, the number of occurrences may be counted through weighted statistics based on the gas feature consistency, to make the determined frequent items come from the return visit users having similar gas features with the current return visit user whose return visit parameters are currently to be determined, so that the frequent items may be related to the gas features of the return visit users whose return visit parameters are currently to be determined, thereby making the questions included in the frequent items more suitable for the return visit users when determining the return visit parameters of the return visit users. By linking the preset number of questions with the return visit necessity of the return visit gas user, the size of the return visit question set may be linked to the return visit necessity of the return visit user. The greater the return visit necessity is, the more the number of return visit questions for the return visit user may be, and the more information about the user may be obtained. By introducing the return visit interval into the return visit parameters, the return visit process may be more user-friendly, and the quality of the return visit service may also be improved from one aspect.

FIG. 6 is a model structure diagram illustrating an occurrence probability prediction model according to some embodiments of the present disclosure.

In some embodiments, a processor in a smart gas management platform 130 may process gas user-related features and candidate estimated occurrence time combinations of gas users including gas call consultation data based on the occurrence probability prediction model, and determine an estimated occurrence probability of a corresponding call of the gas users under each candidate estimated occurrence time combination. The gas user-related features may include gas user features, gas transportation features, gas usage features, historical fault features, and gas call consultation data. More descriptions of the gas user features and the gas call consultation data may be found in the descriptions in FIG. 2. More descriptions of the candidate estimated occurrence time combinations and the estimated occurrence probabilities thereof may be found in the descriptions in FIG. 3. More descriptions of the gas transportation features, the gas usage features and the historical fault features may be found in the descriptions in FIG. 5.

The occurrence probability prediction model may refer to a machine learning model used to determine the estimated occurrence probabilities corresponding to the candidate estimated occurrence time combinations. In some embodiments, the occurrence probability prediction model may include various models such as a recurrent neural network (RNN) model, a deep neural network (DNN) model, a convolutional neural network (CNN) model, etc., or a combination thereof.

As shown in FIG. 6, an input of the occurrence probability prediction model 630 may include the gas user-related features 610 of a certain gas user and the candidate estimated occurrence time combinations 620, and an output of the occurrence probability prediction model 630 may be estimated occurrence probabilities 640 of corresponding calls of the gas users under the candidate estimated occurrence time combinations. The gas user-related features 610 may include gas user features 611, gas transportation features 612, gas usage features 613, historical fault features 614 and gas call consultation data 615.

In some embodiments, as shown in FIG. 6, the input of the occurrence probability prediction model 630 may further include a count 650 of return visit question frequent items of the return visit gas users in the return visit selectable domain. The count of return visit question frequent items of the return visit gas users in the return visit selectable domain may refer to a count of return visit question frequent items, such as 4. More descriptions of the return visit selectable domain may be found in the descriptions in FIG. 4. More descriptions of the return visit question frequent items may be found in the descriptions in FIG. 5.

In some embodiments, the occurrence probability prediction model 630 may be obtained by training a plurality of first training samples labeled with first labels. For example, the plurality of first training samples labeled with the first labels may be input into an initial occurrence probability prediction model, a first loss function may be constructed through the first labels and results of the initial occurrence probability prediction model, and parameters of the initial occurrence probability may be updated iteratively based on the first loss function. When the loss function of the initial occurrence probability prediction model satisfies a preset condition for the end of training, the model training may be completed, and a trained occurrence probability prediction model may be obtained. The preset condition for the end of the training may be that the first loss function converges, the number of iterations reaches a threshold, or the like.

In some embodiments, the first training samples may include sample gas user-related features and sample occurrence time combinations. The first labels may include whether a sample gas user in the first training samples makes a call under the corresponding occurrence time combination. The sample gas user-related features may include sample gas user features, sample gas transportation features, sample gas usage features, sample historical fault features, and sample gas call consultation data. The sample gas user features may be determined based on an installation record of gas terminal equipment used by the sample gas user. The sample gas transportation features may be obtained based on a thermometer, a barometer and a flow meter arranged on a smart gas object platform 150. The sample gas usage features may be obtained based on a gas meter arranged on the smart gas object platform 150. The sample historical fault features may be obtained based on a repair record of the gas user. The sample gas call consultation data may be obtained based on call record data of a call center. The sample occurrence time combinations may be set manually. The first labels may be determined based on manual labeling.

In some embodiments, if the input of the occurrence probability prediction model further includes the count of return visit question frequent items of the return visit gas users in the return visit selectable domain, the first training samples may further include a count of samples of the return visit question frequent items. The count of the samples of the return visit question frequent items may be set manually.

In some embodiments of the disclosure, the estimated occurrence probabilities corresponding to the candidate estimated occurrence time combinations may be determined through the model, which may ensure the accuracy of the estimated result and improve the efficiency of the estimation work.

FIG. 7 is a model structure diagram illustrating a return visit effect prediction model according to some embodiments of the present disclosure.

In some embodiments, a processor in a smart gas management platform 130 may determine evaluation values of candidate return visit question sets by processing the candidate return visit question sets based on the return visit effect prediction model. More descriptions of the candidate return visit question sets and the evaluation values thereof may be found in the descriptions in FIG. 5.

The return visit effect prediction model may refer to a machine learning model for determining the evaluation values of the candidate return visit question sets. In some embodiments, the return visit effect prediction model may include various models such as a recurrent neural network (RNN) model, a deep neural network (DNN) model, a convolutional neural network (CNN) model, etc., or a combination thereof.

As shown in FIG. 7, an input of the return visit effect prediction model 730 may include gas user-related features 710 of a certain gas user and candidate return visit question sets 720, and an output of the return visit effect prediction model 730 may include the evaluation values 740 of the candidate return visit question sets. The gas user-related features 710 may include gas user features 711, gas transportation features 712, gas usage features 713, historical fault features 714 and gas call consultation data 715. More descriptions of the gas user-related features may be found in the descriptions in FIG. 6.

In some embodiments, as shown in FIG. 7, the input of the return visit effect prediction model 730 may further include a return visit interval 750 and a historical return visit frequency 760. More descriptions of the return visit interval and the historical return visit frequency may be found in the descriptions in FIG. 5.

In some embodiments, the return visit effect prediction model 730 may be obtained by training a plurality of second training samples labeled with second labels. For example, the plurality of second training samples labeled with the second labels may be input into an initial return visit effect prediction model, a second loss function may be constructed through the second labels and results of the initial return visit effect prediction model, and parameters of the initial occurrence may be updated iteratively based on the second loss function. When the loss function of the initial return visit effect prediction model satisfies a preset condition for the end of training, the model training may be completed, and a trained return visit effect prediction model may be obtained. The preset condition for the end of the training may be that the second loss function converges, the number of iterations reaches a threshold, or the like.

In some embodiments, the second training samples may include sample gas user-related features and sample return visit question sets. The second labels may include evaluation values corresponding to the sample return visit question sets in the second training samples for sample gas users. The sample gas user-related features in the second training samples may be the same as the sample gas user-related features in the first training samples. More descriptions of the first training samples may be found in the descriptions in FIG. 6. The return visit questions in the sample return visit question sets may be set manually. The second labels may be determined based on manual labeling.

In some embodiments, if the input of the return visit effect prediction model further includes a return visit interval and a historical return visit frequency, the second training samples may further include a sample return visit interval and a historical sample return visit frequency. The sample return visit interval may be set manually; and the historical sample return visit frequency may be obtained based on historical return visit records of the return visit gas users.

In some embodiments of the present disclosure, the evaluation values of the candidate return visit question sets may be determined by the model, which may ensure the accuracy of the determination result and improve the efficiency of the determination work. The accuracy of the results determined by the model may be further improved by introducing the return visit interval and the historical return visit frequency into the input of the model.

Having thus described the basic concepts, it may be rather apparent to those skilled in the art after reading this detailed disclosure that the foregoing detailed disclosure is intended to be presented by way of example only and is not limiting. Although not explicitly stated here, those skilled in the art may make various modifications, improvements, and amendments to the present disclosure. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure, or characteristic described in connection with the embodiment is included in at least one embodiment of the present disclosure. Therefore, it is emphasized and should be appreciated that two or more references to “an embodiment” or “one embodiment” or “an alternative embodiment” in various parts of this disclosure are not necessarily all referring to the same embodiment. In addition, some features, structures, or features in the present disclosure of one or more embodiments may be appropriately combined.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. However, this disclosure does not mean that object of the present disclosure requires more features than the features mentioned in the claims. Rather, claimed subject matter may lie in less than all features of a single foregoing disclosed embodiment.

In some embodiments, the numbers expressing quantities or properties used to describe and claim certain embodiments of the present disclosure are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the present disclosure are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the present disclosure disclosed herein are illustrative of the principles of the embodiments of the present disclosure. Other modifications that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

What is claimed is:

1. A method for managing a return visit based on a call center of smart gas, implemented by a smart gas management platform of an Internet of Things (IoT) system for managing a return visit based on a call center of smart gas, comprising:
obtaining gas call consultation data of one or more gas users, the gas call consultation data including at least a call type distribution;
determining a return visit gas user based on the gas call consultation data of one or more gas users; and
determining return visit parameters based on the gas call consultation data of the return visit gas user and gas user features of the return visit gas user, the gas user features including at least a gas terminal type, and the return visit parameters including at least a return visit question set.

2. The method of claim 1, wherein the determining a return visit gas user based on the gas call consultation data of one or more gas users includes:
determining return visit necessity of each gas user based on the gas call consultation data of one or more of the gas users; and
determining the return visit gas user based on the return visit necessity of each gas user.

3. The method of claim 2, wherein the determining return visit necessity of each gas user based on the gas call consultation data of one or more of the gas users includes:
for each gas user, determining an estimated occurrence probability of a corresponding call of the gas user under each candidate estimated occurrence time combination based on gas user-related features including the gas call consultation data through an occurrence probability prediction model, the candidate estimated occurrence time combination including estimated occurrence time of one or more different types of calls in the future, and the occurrence probability prediction model being a machine learning model; and
determining the return visit necessity based on the estimated occurrence probability of each candidate estimated occurrence time combination.

4. The method of claim 3, wherein an input of the occurrence probability prediction model further includes a count of return visit question frequent items of the return visit gas user in a return visit selectable domain.

5. The method of claim 3, wherein the determining the return visit necessity based on the estimated occurrence probability includes:
determining the candidate estimated occurrence time combination satisfying an occurrence probability threshold condition as a target estimated occurrence time combination; and
determining the return visit necessity by performing weighted processing on at least one target estimated occurrence time combination.

6. The method of claim 2, wherein the determining the return visit gas user based on the return visit necessity of each gas user includes:
determining a gas user whose the return visit necessity satisfies a return visit threshold as the return visit gas user, the return visit thresholds of different gas users being different, and the return visit threshold of the gas user being related to a historical return visit frequency of the gas user.

7. The method of claim 1, wherein the determining return visit parameters based on the gas call consultation data of the return visit gas user and gas user features of the return visit gas user includes:
determining a return visit selectable domain based on the gas user features of the return visit gas user, the return visit selectable domain including at least return visit questions for inquiry; and
determining the return visit parameters based on the return visit selectable domain.

8. The method of claim 7, wherein the determining the return visit parameters based on the return visit selectable domain includes:
obtaining at least one return visit question frequent item, the return visit question included in the return visit question frequent item being included in the return visit selectable domain;
determining a plurality of candidate return visit question sets based on the return visit question frequent items;
determining an evaluation value of each candidate return visit question set based on a return visit effect prediction model, the evaluation value including at least a positive demand generation frequency and a negative demand generation frequency;
determining a target return visit question set based on the evaluation value of each candidate return visit question set; and
determining the return visit parameters based on the target return visit question set.

9. The method of claim 8, wherein the return visit question frequent items are related to a gas feature consistency between a historical return visit gas user in historical return visit records and a current return visit gas user, and the gas feature consistency is determined based on the gas user features, gas transportation usage features, historical fault features, and the gas call consultation data.

10. The method of claim 8, wherein the return visit parameters further include a return visit interval; and an input of the return visit effect prediction model further includes the return visit interval and a historical return visit frequency.

11. The method of claim 1, wherein an IoT system further includes a smart gas user platform, a smart gas service platform, a smart gas sensor network platform, and a smart gas object platform;
the gas user features are obtained based on the smart gas object platform, and are transmitted to the smart gas management platform based on the smart gas sensor network platform; and
the return visit parameters are determined based on the smart gas management platform, and are transmitted to the smart gas user platform based on the smart gas service platform.

12. The method of claim 11, wherein
the smart gas user platform includes a gas user sub-platform, a government user sub-platform and a supervision user sub-platform;
the smart gas service platform includes a smart gas usage service sub-platform, a smart operation service sub-platform and a smart supervision service sub-platform;
the smart gas management platform includes a smart customer service management sub-platform, a smart operation management sub-platform and a smart gas data center;
the smart gas sensor network platform includes a gas indoor equipment sensor network sub-platform and a gas pipeline network equipment sensor network sub-platform; and
the smart gas object platform includes a gas indoor equipment object sub-platform and a gas pipeline network equipment object sub-platform.

13. An Internet of Things (IoT) system for managing a return visit based on a call center of smart gas, comprising a smart gas user platform, a smart gas service platform, a smart gas management platform, a smart gas sensor network platform and a smart gas object platform which interact in sequence, wherein the smart gas management platform includes a smart customer service management sub-platform, a smart operation management sub-platform and a smart gas data center, and the smart gas management platform is configured to:
obtain, through the smart gas data center, gas usage data from at least one gas terminal equipment through the smart gas sensor network platform and send the gas usage data to the smart gas management sub-platform, and the at least one gas terminal equipment is configured in the smart gas object platform;
the smart gas management platform is configured to:
obtain gas call consultation data of one or more gas users, the gas call consultation data including at least a call type distribution;
determine a return visit gas user based on the gas call consultation data of one or more gas users; and
determine return visit parameters based on the gas call consultation data of the return visit gas user and gas user features of the return visit gas user, the gas user features including at least a gas terminal type, and the return visit parameters including at least a return visit question set.

14. The IoT system of claim 13, wherein the smart gas management platform is further configured to:
determine return visit necessity of each gas user based on the gas call consultation data of one or more gas users; and
determine the return visit gas user based on the return visit necessity of each gas user.

15. The IoT system of claim 14, wherein the smart gas management platform is further configured to:
for each gas user, determine an estimated occurrence probability of a corresponding call of the gas user under each candidate estimated occurrence time combination based on gas user-related features including the gas call consultation data through an occurrence probability prediction model, the candidate estimated occurrence time combination including estimated occurrence time of one or more different types of calls in the future, and the occurrence probability prediction model being a machine learning model; and
determine the return visit necessity based on the estimated occurrence probabilities of each candidate estimated occurrence time combination.

16. The IoT system of claim 15, wherein the smart gas management platform is further configured to:
determine the candidate estimated occurrence time combination satisfying an occurrence probability threshold condition as a target estimated occurrence time combination; and
determine the return visit necessity by performing weighted processing on at least one target estimated occurrence time combination.

17. The IoT system of claim 14, wherein the smart gas management platform is further configured to:
determine a gas user whose the return visit necessity satisfies a return visit threshold as the return visit gas user, the return visit thresholds of different gas users being different, and the return visit threshold of the gas user being related to a historical return visit frequency of the gas user.

18. The IoT system of claim 13, wherein the smart gas management platform is further configured to:
determine a return visit selectable domain based on the gas user features of the return visit gas user, the return visit selectable domain including at least return visit questions for inquiry; and
determine the return visit parameters based on the return visit selectable domain.

19. The IoT system of claim 18, wherein the smart gas management platform is further configured to:
obtain at least one return visit question frequent item, the return visit question included in the return visit question frequent item being included in the return visit selectable domain;
determine a plurality of candidate return visit question sets based on the return visit question frequent items;
determine an evaluation value of each candidate return visit question set based on a return visit effect prediction model, the evaluation value including at least a positive demand generation frequency and a negative demand generation frequency;
determine a target return visit question set based on the evaluation value of each candidate return visit question set; and
determine the return visit parameters based on the target return visit question set.

20. A non-transitory computer-readable storage medium storing computer instructions, wherein when the computer instructions are executed by a processor, the method for managing the return visit based on the call center of smart gas of claim 1 is implemented.
